(19) United States
(12) Patent Application Publication
(10) Pub. No.: US 2014/0362558 A1
(43) Pub. Date: Dec. 11, 2014

(54) Luminescent Body For Converting Pump Light

(71) Applicant: OSRAM GMBH, Munich (DE)

(72) Inventor: Andre Nauen, Regensburg (DE)

(73) Assignee: OSRAM GMBH, Munich (DE)

(21) Appl. No.: 14/370,423

(22) PCT Filed: Dec. 17, 2012
(86) PCT No.: PCT/EP2012/075813

§ 371 Date: Jul. 2, 2014

(30) Foreign Application Priority Data
Jan. 2, 2012 (DE) 102012200011.9

(51) Int. Cl. F21V 14/08; F21K 99/00; F21V 9/16

(52) U.S. Cl. CPC F21V 14/08; F21V 9/16; F21K 9/56; F21K 9/58
USPC 362/84; 362/317

(57) ABSTRACT

A phosphor body (1) for converting pump light into converted light, the extent of said phosphor body being greater in a direction of extent (3) than in a direction perpendicular thereto, and which phosphor body is adapted to emit converted light in the direction of extent (3) as a result of illumination with pump light. The phosphor body (1) comprises at least two phosphor body subvolumes (2a,b,c,d), which are configured in such a way that the converted light emitted in each case by said phosphor body subvolumes differs in terms of the spectral properties. The phosphor body subvolumes are arranged successively in a direction oriented perpendicular to the direction of extent.

### TECHNICAL FIELD

The present invention relates to a phosphor body for converting pump light into converted light.

### PRIOR ART

At present, gas discharge lamps are still the most widespread types of light sources of high luminance. However, the most recent developments relate to the combination of a light source having a high power density, for example a laser, with a phosphor element which converts pump light and which is arranged spaced apart from the pump light source. The for example blue or ultraviolet pump light is converted by the phosphor element so that converted light having a longer wavelength is emitted.

The present invention is based on the technical problem of specifying a phosphor body which is advantageous in comparison with the prior art.

### DESCRIPTION OF THE INVENTION

This problem is achieved according to the invention by a phosphor body whose extent in a direction of extent is greater than in a direction perpendicular thereto and which is designed to emit converted light in the direction of extent as a result of an illumination with pump light; in this case, the phosphor body is constructed from at least two phosphor body subvolumes, which are designed in such a way that the converted light emitted in each case by them differs in terms of the spectral properties; the phosphor body subvolumes are arranged successively in a direction oriented perpendicular to the direction of extent.

“Successively” in this case means that, in a sectional plane oriented perpendicular to the direction of extent, it is possible to draw a straight line, in this plane, through at least two phosphor body subvolumes. If, for example, a multiplicity of phosphor body subvolumes is provided, said phosphor body subvolumes can lie on a common straight line, for example, or else can be connectable to one another in each case in pairs by straight lines. The phosphor body subvolumes in this case do not necessarily adjoin one another directly, but can also be spaced apart slightly from one another, for example.

Therefore, a phosphor body is provided whose extent in the direction of extent is greater than in a direction perpendicular thereto, for example, in this order with increasing preference, at least 1.1, 1.25, 1.75, 2, 2.5 times greater.

Owing to the thus elongate, for example, configuration of the phosphor body (and therefore of the phosphor body subvolumes), it is also possible, for example, for a plurality of identical or different pump light sources to be provided along the direction of extent (or for a pump light beam to be correspondingly widened), i.e. for the illumination to take place over a certain length. If, in order to illustrate the principle theoretically, a phosphor body subvolume is divided into regions which are successive in the direction of extent, the converted light emitted by a first phosphor body subvolume region then propagates in the direction of extent by the other adjoining phosphor body subvolume regions and, in the process, is supplemented by the converted light emitted thereby. Then, therefore, converted light can emerge at an emission surface extending, for example, at an angle with respect to the direction of extent (preferably perpendicular thereto), which converted light would, to a certain extent, be “accumulated” in the direction of extent over the length of the phosphor body subvolume and thus has increased luminous flux, for example; the luminance is also correspondingly increased.

The phosphor body can be metal-coated, for example on the outside along the direction of extent; equally, a phosphor body subvolume can also be metal-coated, for example, preferably circumferentially, with the result that, for example in the case of phosphor body subvolumes which are put together, a metal coating can be provided within the phosphor body subvolume as well, for example in order to prevent light mixing between the phosphor body subvolumes. If, however, the phosphor body is only metal-coated on its outer surface, for example, light mixing can also already take place in the phosphor body, for example. In both cases, the metal coating can also be at least regionally dichroitic, for example, firstly in order to enable coupling-in of pump light and secondly in order to prevent converted light from emerging laterally and thus to reduce the lateral emission losses of the light guided in the direction of the emission surface.

However, it is also possible, for example, for a light source with a high luminance to be realized solely using the converted light propagating in the direction of extent (or at a slight angle thereto) because, in this case, the solid angle assumed by an emerging beam and therefore also the etendue (projected solid angle per surface element; see, for example, “Field Guide to Illumination”, Angelo V. Arecchi et al., SPIE Press 2007) of the light are low. The luminance, i.e. the luminous flux per etendue, is correspondingly high.

If no metal coating is provided along the direction of extent, generally some of the converted light is subjected to total internal reflection (TIR) on the outer surface of the phosphor body, for example when the phosphor body is surrounded by a gas such as air, for example. Then, therefore, light is guided in the direction of the emission surface within a certain angular range, which is predetermined by the refractive indices of the phosphor body and the surrounding medium. The presence of an “emission surface” generally, i.e. not necessarily, implies that converted light emerges only at this surface. In general, in order to increase the quantity of light guided in the direction of the emission surface, an outer surface of the phosphor body which is opposite the emission surface and is preferably parallel thereto can also be metal-coated.

A phosphor body according to the invention is constructed from at least two phosphor body subvolumes, whose converted light differs in terms of its spectral properties. It is possible, therefore, for a phosphor mixture of the phosphor body subvolumes to differ in terms of one constituent, i.e. for example in terms of a type of phosphor, for example. The phosphor body subvolumes can be designed, for example, to emit different colors, i.e., for example, to emit light with substantially complementary spectra. Secondly, it is also possible, for example, for a narrow-band emission of one phosphor body subvolume to spectrally superimpose a broadband spectrum of another phosphor body subvolume and thus to supplement it in specific wavelength ranges.

The phosphor body subvolumes are now arranged successively in a direction oriented perpendicular to the direction of extent, i.e. “next to one another” and not “one behind the other” in the direction of extent. This arrangement has proven to be particularly advantageous because it is thus possible to prevent, for example, reabsorption of the converted light of a phosphor body subvolume by the phosphor provided in another phosphor body subvolume; in the case of phosphor body subvolumes which are arranged “one behind the other” in the direction of extent, such a reabsorption of radiation could occur.

Preferably, therefore, a phosphor body subvolume extends in the direction of extent over the entire length of the phosphor body. The phosphor body is therefore particularly preferably constructed exclusively from phosphor body subvolumes arranged “next to one another”, which is particularly advantageous in respect of the avoidance of undesirable interaction of converted light and phosphor of different phosphor body subvolumes.

In a preferred configuration, such an interaction can be suppressed further if a phosphor body subvolume is metal-coated over at least 20%, in order of increasing preference at least 40%, 60%, 80%, of its length, taken in the direction of extent; particularly, preferably it is metal-coated over its entire length. Preferably, the phosphor body subvolume is metal-coated towards another phosphor body subvolume, i.e. the metal coating can then (also) be arranged within the phosphor body; particularly preferably, the metal coating of the phosphor body subvolume is provided circumferentially, i.e. in this case arranged possibly on the outside and within the phosphor body.

Further preferably, the metal coating is at least regionally dichroitic, with the result that, for example, pump light is transmitted, but converted light or light from another subvolume is reflected.

As phosphor body, for example, a phosphor embedding matrix can be provided in which the phosphor particles are ideally finely dispersed in solution; the phosphor body may be, for example, a ceramic body, for example doped yttrium-aluminum-garnet (YAG). Thus, for example, with Eu-doped YAG, a red phosphor is produced and, with Ce-doped YAG, a green phosphor; Eu-doped barium-magnesium-aluminate (BAM) can be provided as blue phosphor, for example.

In general, the phosphor body is not necessarily integral, but rather the phosphor body subvolumes can also be put together as parts which are produced separately from one another, for example, and preferably fixed in a relative position with respect to one another, for example by means of a joint. In a preferred configuration, the phosphor body subvolumes can therefore be adhesively bonded to one another, for example.

Further preferred configurations are set forth in the remaining dependent claims and in the description below, wherein, as throughout the disclosure, no specific distinction is drawn between the description of a phosphor body and an illumination unit comprising such a phosphor body; in addition, the invention is also directed to use aspects and the individual features are also intended to be disclosed in the respective other categories of the invention.

In general, it is also possible, for example, for a flat element to be provided as phosphor body, in which case the direction of extent corresponds to a surface direction and the phosphor body subvolumes are arranged successively in the surface direction perpendicular thereto. The converted light is then emitted at an end side, which, owing to the small extent, is correspondingly narrow perpendicular to the surface plane. Preferably, the length of the phosphor body in the direction of extent is not only longer than in a direction perpendicular thereto, however, but also longer than in two directions perpendicular to the direction of extent and to one another. Particularly preferably, the length ratios mentioned at the outset for one direction then also apply in respect of these two directions.

In a preferred configuration, the phosphor body subvolumes are not only arranged successively, but circumferentially, to be precise about a common axis oriented in the direction of extent. When viewed in a sectional plane oriented perpendicular to the direction of extent, this axis preferably lies within the phosphor body; if the phosphor body is formed continuously, when viewed in this sectional plane, it possibly encloses a “cavity”, which can contain the axis.

A phosphor body comprising circumferentially arranged phosphor body subvolumes can further preferably rotate about an axis of rotation oriented along the direction of extent (preferably parallel thereto) during operation, wherein, as a result of the rotation, different sides of the phosphor body are illuminated with pump light. It is then also possible, therefore, for one or more stationary pump light sources, for example, to illuminate different phosphor body subvolumes as a result of the rotation and thus for light mixing to be performed, when averaged over time, for example.

The pump light source in this case does not necessarily need to be operated continuously, but the pump light can also have, for example, a varying intensity, with the result that, for example, different phosphor body subvolumes are illuminated with a different intensity so as to match the speed of rotation.

In general, the converted light can be picked off, for example, from the entire emission surface, which results as a sum of the emission surfaces of the individual phosphor body subvolumes, and mixed, for example, in a non-imaging optical element, for example in a “Compound Parabolic Concentrator” (CPC), for further use. Secondly, the converted light can however also be picked off only from a subregion of the emission surface, for example in the case of a rotating phosphor body, with the result that light mixing is performed, when averaged over time. In this way, for example, the illumination unit of a projection device can be operated, it being possible for the light from said illumination unit to then be guided selectively into an image plane via a micromirror array, clocked with the rotation.

The advantage of illumination along the direction of extent consists in that the quantity of pump light coupled in per (imaginary) phosphor body region can be kept high over the length in the direction of extent, to be precise also in the case of a penetration depth of the pump light which is limited owing to the absorption.

As mentioned at the outset, for example, the light from a single pump light source can also be spread out in the direction of extent. Preferably, however, a plurality of pump light sources is provided, for example a plurality of light-emitting diode(s) and/or laser diode(s), i.e. also any desired combination thereof. However, laser pump light sources are particularly preferred. “Pump light” in the context of this disclosure therefore initially relates to electromagnetic radiation whose wavelength can also be on the other side of the visible range, for example in the ultraviolet or infrared range. In general, “illumination” also has a correspondingly general meaning, namely as “irradiation”. “Pump light” can even also include corpuscular radiation, for example radiation of electrons or ions; however, illumination with an LED or with a laser is preferred.

If, in the context of this disclosure, reference is made to light propagation, light propagation does not necessarily also need to take place in order to realize the subject matter, but rather the phosphor body or the illumination unit should merely be designed for a corresponding propagation.

As already mentioned at the outset, the invention is also directed to an illumination unit comprising a plurality _{of} pump light sources; these pump light sources do not necessarily need to be arranged along the direction of extent, but can also be distributed circumferentially (independently thereof or in addition thereto). Different phosphor body subvolumes can then be illuminated with different pump light sources, to be precise in combination with or independently of a rotation.

The invention also relates to the use of one of the above-described illumination units for a projection device or endoscope, for interior lighting applications or else for industrial or medical applications in general.

### BRIEF DESCRIPTION OF THE DRAWINGS

The invention will be explained in more detail below with reference to exemplary embodiments, wherein the individual features can also be essential to the invention in other combinations.

Specifically,

FIG. 1 shows a phosphor body according to the invention;

FIG. 2 shows an illumination unit according to the invention;

FIG. 3 shows different phosphor body subvolume combinations.

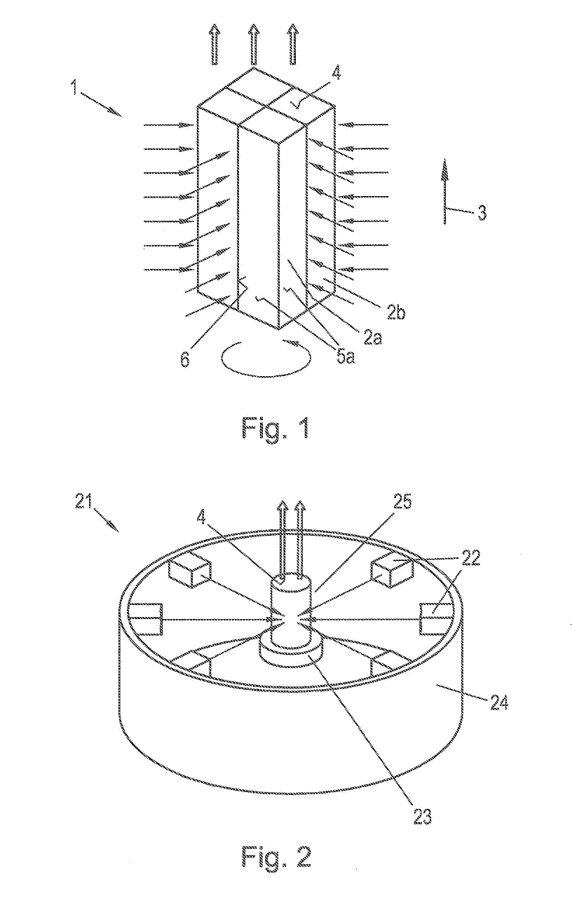

FIG. 1 shows a phosphor body 1, which is assembled from a plurality of phosphor body subvolumes 2a,b,c,d (for reasons of clarity only 2a and 2b are provided with references in the figure; this also applies to the components described below, without this being elucidated specifically in each case). The phosphor body subvolumes 2a,b,c,d extend in the direction of extent 3 over the entire length of the phosphor body 1 up to an emission surface 4 (this results as a sum of the emission surfaces of the individual phosphor body subvolumes 2a,b,c,d) and are illuminated with pump light at lateral radiation entry surfaces 5a,b,c,d along the direction of extent 3. Then, converted light propagates in the direction of extent 3 (although not only in this direction), the intensity of said converted light increasing in the direction of extent 3, which converted light emerges at the emission surface 4a,b,c,d (non-solid arrows).

The phosphor body 1 can be illuminated, for example, with circumferentially provided pump light sources, as shown in detail in FIG. 2. The phosphor body 1 can, however, also be mounted rotatably about an axis parallel to the direction of extent 3 and then illuminated also only from one side, for example. A rotation of the phosphor body 1 is also possible, however, in conjunction with circumferentially arranged pump light sources (cf. FIG. 1) and can be advantageous, for example, in respect of cooling of the phosphor body 1.

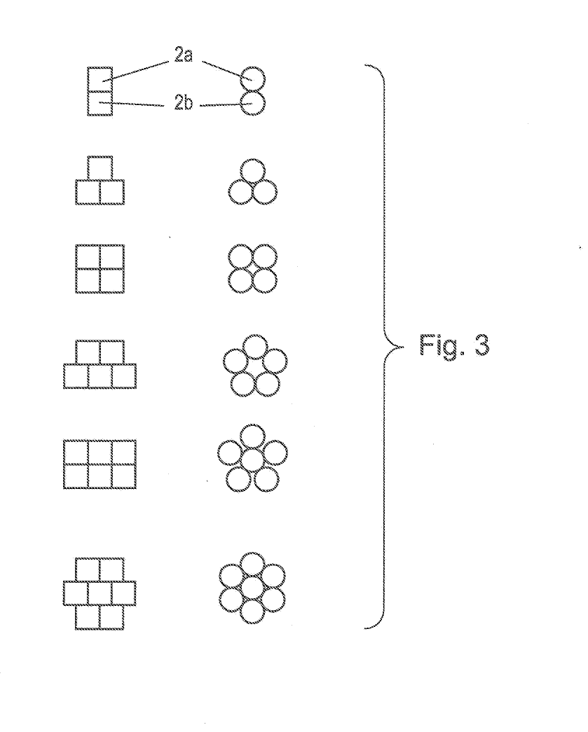

In this case, four phosphor body subvolumes 2a,b,c,d which are produced separately from one another and are then connected to one another via adhesive joints 6 are illustrated, which can be designed, for example, to emit red, green and blue converted light, supplemented by, for example, a phosphor body subvolume emitting white or yellow light (the former can increase the luminous efficacy, for example, and the latter can be advantageous in respect of the color space, for example). In respect of further phosphor body subvolume combinations, reference is made to FIG. 3.

FIG. 2 shows an illumination unit 21 comprising a phosphor body 1, around which laser diodes 22 are provided circumferentially as pump light sources (the phosphor body subvolumes are not illustrated for reasons of clarity). The phosphor body 1 is mounted on a heat sink 23, which at the same time represents a mirror opposite the emission surface 4 of the phosphor body 1 and reflects converted light propagating downwards in the figure in the direction of the emission surface 4.

The laser diodes 22 are also for their part mounted on a heat sink 24; in this case, a common cooling ring 24 is shown, but it is also possible for individual heat sinks to be provided. For heat dissipation, the entire arrangement can have a flow of cooling air circulating around it, for example. This is a Particular advantage of the laser diodes 22 which are arranged spaced apart from the phosphor body 1 in comparison with light-emitting diodes provided directly on the surface of the phosphor body 1, for example.

The outer surfaces of the phosphor body 1 which are perpendicular to the emission surface 4, i.e. the radiation entry surfaces, are provided with a dichroitic layer 25, which is transmissive to pump light, but is reflective to converted light.

FIG. 3 shows a series of possible combinations of different bar-shaped phosphor body subvolumes 2a,b. The bars are cuboidal (on the left in the figure) or cylindrical (on the right in the figure).

For example, using two bars, a phosphor emitting red converted light can be combined with a phosphor emitting broadband green converted light, which results in a warm-white, pleasant light. The combination of three bars can be used in particular for mixing red, green and blue light (RGB). In the case of a fourth bar, RGB can be supplemented by white or yellow light, for example; secondly, it is also possible, for example, for a second bar to be provided for one of the three colors (RGB), for example in order to supplement a phosphor with relatively low efficiency in a targeted manner. This is of course also applicable to five bars or any other desired number of bars.

In the case of six bars, therefore, in each case two bars can be provided per color (RGB), for example; secondly, the RGB color space can also be supplemented in a targeted manner, as a result of a combination of yellow, cyan and magenta phosphor (YCM), for example. It is of course possible in the case of an arrangement with two bars per primary color (RGB) to also additionally provide a white phosphor bar for optimizing the brightness and/or a yellow phosphor which is advantageous in respect of the color space.

1. A phosphor body for converting pump light into converted light, the extent of said phosphor body being greater in a direction of extent than in a direction perpendicular thereto, and which phosphor body is adapted to emit converted light in the direction of extent as a result of illumination with pump light, wherein the phosphor body comprises at least two phosphor body subvolumes, which are configured in such a way that the converted light emitted in each case by said phosphor body subvolumes differs in terms of the spectral properties, which phosphor body subvolumes are arranged successively in a direction oriented perpendicular to the direction of extent.

2. The phosphor body as claimed in claim 1, the extent of said phosphor body in the direction of extent being greater than in two directions perpendicular thereto and to one another.

3. The phosphor body as claimed in claim 1, wherein the phosphor body subvolumes are arranged circumferentially a common axis oriented in the direction of extent.

4. The phosphor body as claimed in claim 1, wherein a phosphor body subvolume extends in the direction of extent over the entire length of the phosphor body.

5. The phosphor body as claimed in claim 1, wherein the phosphor body subvolumes are put together as individual parts which are produced separately from one another, and are connected by a joint.

6. The phosphor body (4) as claimed in claim 5, wherein a phosphor body subvolume is metal-coated over at least 20% of its length, taken in the direction of extent.

7. The phosphor body claimed in claim 6, wherein the metal coating is at least regionally dichroitic.

8. An illumination unit comprising a phosphor body as claimed in claim 1 and a plurality of pump light sources.

9. The illumination unit as claimed in claim 8, wherein a plurality of pump light sources is arranged distributed circumferentially in such a way that different phosphor body subvolumes can be illuminated with different pump light sources.

10. The illumination unit as claimed in claim 8, wherein the phosphor body is configured to rotate about an axis of rotation oriented along the direction of extent, wherein, as a result of the rotation, different sides of the phosphor body and therefore different phosphor body subvolumes can be illuminated with pump light.

11. (canceled)

12. The phosphor body as claimed in claim 5, wherein a phosphor body subvolume is metal-coated over at least 20% of its length, taken in the direction of extent toward another phosphor body subvolume.

13. An illumination unit comprising a phosphor body as claimed in claim 1 and a plurality of laser pump light sources.
